(19) United States
(12) Patent Application Publication
(10) Pub. No.: US 2005/0191405 A1
(43) Pub. Date: Sep. 1, 2005

(54) Starch-molded fruit snack puzzle

(76) Inventors: Emery Stephen Okos, Battle Creek, MI (US); Nicolas Amaya, Kalamazoo, MI (US); Roger Steven Wenk, Battle Creek, MI (US); Sylvia Lynn Schonauer, Battle Creek, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/055,324

(22) Filed: Feb. 10, 2005

Related U.S. Application Data
(60) Provisional application No. 60/543,180, filed on Feb. 10, 2004.

(51) Int. Cl. A23G 3/00

(52) U.S. Cl. 426/658

(57) ABSTRACT

A food product for providing play value to consumers is provided. The food product comprises a plurality of individual, edible food pieces having various complementary shapes such that the food pieces can be arranged as a puzzle to form an increasingly complex and recognizable structure. Each of the plurality of food pieces are starch-molded fruit pieces comprising from 40 to 70 weight percent sweetener, from 1 to 8 weight percent fruit, and from 0.01 to 15 weight percent gelling agent.

### RELATED APPLICATIONS

This application claims the benefit of U.S. provisional patent application Ser. No. 60/543,180, filed Feb. 10, 2004, the advantages and disclosure of which are herein incorporated by reference.

### STATEMENT REGARDING FEDERALLY SPONSORED RESEARCH

None

### FIELD OF THE INVENTION

The present invention relates generally to a food product that provides play value to consumers. More specifically, the present invention relates to the food product comprising a plurality of individual food pieces that can be arranged by consumers as a puzzle to form increasingly complex and recognizable structures.

### BACKGROUND OF THE INVENTION

Using individual food pieces to create an edible puzzle is well known in the art. Edible puzzles provide added play value to the particular food product in which they are incorporated to increase consumption by consumers. A typical edible puzzle comprises a plurality of edible food pieces of different configurations, e.g., shapes and sizes, that are complementary to one another such that the food pieces can be arranged to form increasingly complex and recognizable structures.

One such puzzle is shown in U.S. patent application Publication No. 2003/0152668 to Griffin. Griffin discloses an edible puzzle that includes a plurality of individual food pieces that can be arranged by consumers to form increasingly complex and recognizable structures. For instance, in one embodiment, Griffin discloses food pieces in the shapes of a threaded bolt and a nut, with these food pieces being capable of actual assembly. The food pieces in Griffin are preferably confectionery based food pieces such as hard sugar confections.

U.S. Pat. No. 5,579,582 to Carlson discloses a cookie cutter than can be used to form a plurality of food pieces for use in an edible puzzle. Carlson suggests that the food pieces may be arranged to form a geometric shape, an animal or other caricature or representation.

Japanese Patent Application No's 9-038364 and 2002-223701 also disclose edible puzzles that include a plurality of individual food pieces that can be arranged by consumers to form increasingly complex and recognizable structures. Application No. 9-038364 discloses food pieces being arranged to form plates, pots, and dolls with the food pieces being confectionery pieces such as a rice cracker, a cookie, a biscuit, or a chocolate. Application No. 2002-223701 discloses food pieces being arranged to form an animal or other character with the food pieces being confectionery pieces.

Each of these prior art references disclose edible puzzles comprising individual food pieces that can be arranged to form increasingly complex and recognizable structures. These references also disclose the food pieces being confections. However, none of these prior art references disclose, teach, or suggest using starch-molded fruit snacks for this purpose.

### BRIEF SUMMARY OF THE INVENTION

The present invention provides a food product for providing play value to consumers. The food product comprises a plurality of individual, edible food pieces having various complementary configurations such that the food pieces can be arranged as a puzzle to form an increasingly complex and recognizable structure. Each of the plurality of food pieces are starch-molded fruit snack pieces.

In one aspect of the present invention, each of the plurality of food pieces resembles a segment of a worm such as a body and a head of the worm with the head and body pieces having complementary portions to interconnect the pieces to form the worm.

In further aspects of the invention, each of the plurality of food pieces can be arranged to form an animal (mammal, bird, insect, fish, etc.), animated character, creature, inanimate object, word or phrase, and the like.

### BRIEF DESCRIPTION OF THE SEVERAL VIEWS OF THE DRAWINGS

Advantages of the present invention will be readily appreciated as the same becomes better understood by reference to the following detailed description when considered in connection with the accompanying drawings wherein:

FIG. 1 is a perspective view of an edible puzzle of the present invention comprising a plurality of food pieces arranged to form a skeleton-like creature;

FIG. 2 is a perspective view of an edible puzzle of the present invention comprising a plurality of food pieces arranged to form a skeleton-like creature;

FIG. 3 is a perspective view of an edible puzzle of the present invention comprising a plurality of food pieces arranged to form a biped;

FIG. 4 is a perspective view of an edible puzzle of the present invention comprising a plurality of food pieces arranged to form a canine;

FIG. 5 is a perspective view of an edible puzzle of the present invention comprising a plurality of food pieces arranged to form a spider;

FIG. 6 is a perspective view of an edible puzzle of the present invention comprising a plurality of food pieces arranged to form a bird;

FIG. 7 is a top view of an edible puzzle showing multiple complex and recognizable structures to be formed from individual food pieces;

FIG. 8 is a top view of an edible puzzle of the present invention comprising a plurality of food pieces having alphabetic characters arranged to form a word; and

FIG. 9 is a perspective view of an edible puzzle of the present invention comprising a plurality of food pieces arranged to form an animated character.

### DETAILED DESCRIPTION OF THE INVENTION

Referring to the Figures, wherein like numerals indicate like or corresponding parts throughout the several views, a food product for providing play value to consumers is generally indicated at 10. The food product is in the form of an edible puzzle 10 comprising a plurality of individual and edible food pieces 12, i.e., puzzle pieces, of various configurations, e.g., shapes and sizes. The configurations are complementary to one another such that the food pieces 12 can be arranged to form increasingly complex and recognizable structures, e.g., animals (mammal, bird, insect, fish, etc.), animated characters, creatures, inanimate objects, words or phrases, and the like. The term puzzle as used herein refers to the food pieces 12 and their capacity to be arranged to form increasingly complex and recognizable structures, i.e., the puzzle pieces 12 are designed for providing play value by testing ingenuity. In many of the embodiments set forth below, the puzzle pieces 12 are further capable of being arranged in multiple ways to form multiple increasingly complex and recognizable structures, i.e., the edible puzzles have multiple solutions.

Each of the plurality of food pieces 12 is preferably starch-molded. More preferably, the food pieces 12 are starch-molded fruit snack pieces. Starch-molded fruit snacks have become popular food items. While many compositions have been employed in the preparation of such starch-molded fruit snacks, the most typical composition comprises an aqueous dispersion of various sweeteners, fruit, and a gelling agent.

Any conventional starch-molded fruit snack formulation may be employed for preparing the food pieces 12 of the present invention. Generally, the formulation for the food pieces 12 comprises from 30 to 90 weight percent sweetener, more preferably from 40 to 70 weight percent (weight percent is based on a total weight of a pre-boiled mixture of the ingredients). The food pieces 12 also comprise fruit in amounts of from 0.01 to 30 weight percent, more preferably from 1 to 10 weight percent, and most preferably from 1 to 8 weight percent. The gelling agent is preferably present in amounts of from 0.01 to 15 weight percent, more preferably from 0.01 to 10 weight percent. The food pieces 12 preferably have a finished moisture content of from 10 to 30 percent, more preferably from 13 to 25 percent, and most preferably from 16 to 20 percent.

The sweetener can be in the form of sucrose, dextrose, fructose, crystalline fructose, lactose, malt syrup, malt syrup solids, rice syrup solids, rice syrup, sorghum syrup, invert sugar, refiners syrup, corn syrup, corn syrup solids, maltose, high fructose corn syrup, honey, molasses, sugar alcohols, maltodextrin, or combinations thereof. It should be appreciated that a “no sugar added” food product could also be formulated using sorbitol and other sugar alcohols.

The fruit may include fruit powder, drum-dried fruit solids, freeze-dried fruit solids, or evaporated fruit puree or fruit juice concentrate with at least 40 percent fruit solids. It should be noted that fruits such as cleaned, de-capped, fresh strawberries contain only 6 to 9.5 lbs. of solids per hundred-weight, i.e., 6 to 9.5 percent solids. Hence, the formulation provided herein uses a concentrated source of fruit.

Suitable gelling agents include gelatin, gellan gum, carbohydrate gel forming polymers, e.g., pectin, gel forming starches, alginates, agar, etc., and mixtures thereof. Pectin and gel forming starches such as corn starch are preferred.

The formulation for the food pieces 12 may include edible oils or shortenings in an amount of from 0 to 5 weight percent, more preferably from 0.01 to 3 weight percent. Examples of edible oils or shortenings that could be used include partially hydrogenated vegetable oils such as natural or hydrogenated soybean, cottonseed, canola, peanut, safflour, sunflour, coconut, palm, palm kernel, olive, butterfat, cocoa butter, tallow, lard, corn oil, or combinations thereof.

The formulation for the food pieces 12 may include a humectant such as glycerin for moisture retention in an amount of from 0 to 2 weight percent. Other examples of humectants that could be used include sorbitol solution, a mixture of glycerin and sorbitol, fructose, propylene glycol, or combinations thereof.

A food grade acid such as citric acid can be added to the formulation to adjust pH. The food grade acid may be present in the food pieces 12 in amounts of from 0 to 3 weight percent, more preferably from 0 to 1 weight percent, and most preferably from 0.01 to 0.9 weight percent. Other food grade acids that could be used include malic acid, tartaric acid, ascorbic acid, phosphoric acid, lactic acid, acetic acid, adipic acid, glucono delta lactone acid, fumaric acid, succinic acid, tarenic acid, potassium citrates, or combinations thereof.

A buffer such as sodium citrate may be present in amounts of from 0 to 1 weight percent to control pH.

Salt may be added in amounts of from 0 to 2 weight percent to provide flavor enhancement. The salt is chosen from, but is not limited to, potassium chloride, calcium chloride, or combinations thereof.

An emulsifier such as glyceryl monostearate may be present in the formulation to maintain product softness over time. The emulsifier is present in a preferred amount of from 0 to 3 weight percent. Other emulsifiers could also be used such as glycerol esters, diacetyl tartaric acids, esters of monoglycerides, mono and di-glycerides, polyglycerol esters, polysorbate, propylene glycol esters, rice extract esters, sodium stearoyl-2-lactylate, sorbitan esters, sugar esters, acetylated monoglycerides, lecithin, or combinations thereof.

A preservative such as potassium sorbate may also be present in the formulation in a preferred amount of from 0 to 1 weight percent. Other preservatives such as sodium propionate or potassium benzoate could be used as well.

Colors and flavors can also be added to form the food pieces 12 in preferred amounts of from 0 to 3 weight percent, more preferably from 0.01 to 2 weight percent.

A glazing agent such as carnauba wax and beeswax may also be present in the formulation in an amount of from 0 to 2 weight percent, more preferably from 0.01 to 0.5 weight percent.

It should be appreciated that the edible oil, humectant, food grade acid, buffer, salt, emulsifier, preservative, colors and flavors, and glazing agent are optional ingredients. The most preferred ingredients and their ranges are shown in the following TABLE 1 with an example formulation provided as EXAMPLE 1:

TABLE 1

| Ingredient | Weight % |
|---|---|
| Water | 30.6-35.8% |
| Corn Syrup, Liquid | 20.2-30.9% |
| Sugars | 22.2-28.4% |
| Starch, Food Grade | 4.2-8.6% |
| Natural Juice Concentrate | 3.3-6.6% |
| Pectin | 0.54-0.63% |
| Glazing agent | 0.26-0.36% |
| Acid solution | 0.66-086% |
| Flavors, Natural and Artificial | 0.12-0.34% |
| Colors, Natural and Artificial | 0.01-0.03% |
| TOTAL | 100% |

### EXAMPLE 1

| Ingredient | Weight % |
|---|---|
| Water | 34% |
| Corn Syrup, Liquid | 26% |
| Sugars | 26% |
| Starch, Food Grade | 6.5% |
| Natural Juice Concentrate | 5.5% |
| Pectin | 0.60% |
| Glazing agent | 0.30% |
| Acid solution | 0.75% |
| Flavors, Natural and Artificial | 0.32% |
| Colors, Natural and Artificial | 0.025% |
| TOTAL | 100% |

The food pieces 12 are typically cast, i.e., deposited as an aqueous dispersion into starch beds (starch mold generally formed of dry starch that has been imprinted with the desired 3-D shape). In this casting system, referred to in the trade as the Mogul system, the ingredients are typically cooked to temperatures of from 200 to 350 degrees Fahrenheit, more preferably to temperatures of from 240 to 280 degrees Fahrenheit (depending on the desired viscosity of the mixture), which boils off much of the initial water in the formulation. The cooked mixture is then deposited as a thin, hot liquid into the starch beds. The starch in the starch bed forms the food pieces 12 and serves to reduce the moisture content of the food pieces 12 to the level of the end product. The finished food pieces 12 are then packaged using a typical packaging unit.

It should of course be appreciated that the sample formulation and processing is by way of example only. The food pieces 12 of the present invention can be formed using any conventional fruit snack formulations and/or starch-molding processing techniques. Examples of sample formulations and processing techniques that may be employed in manufacturing the food pieces 12 are disclosed in U.S. Pat. Nos. 6,077,557; 6,444,252; 6,528,102; and 6,596,334, all of which are herein incorporated by reference.

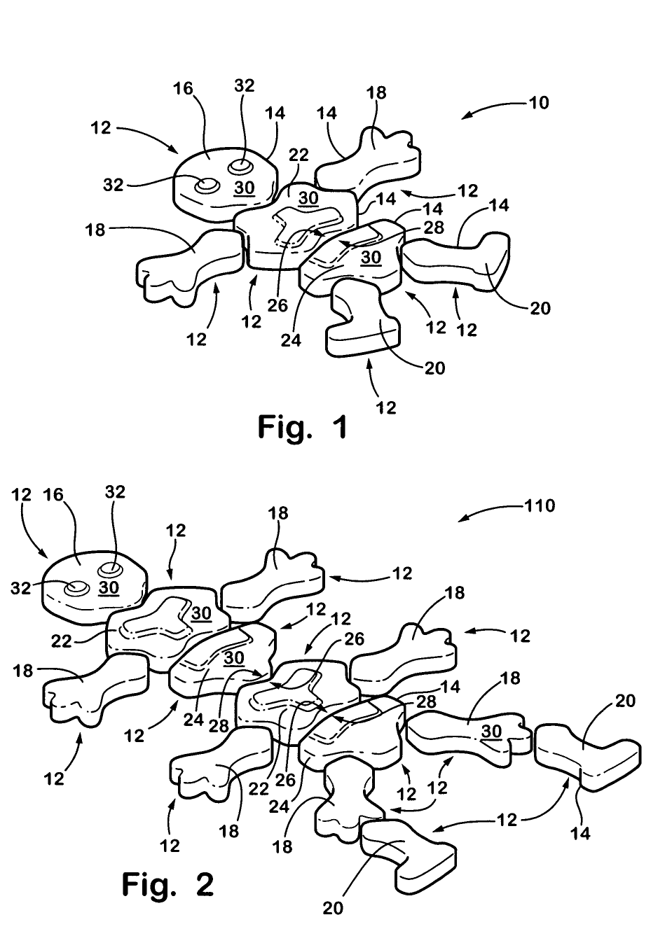

Referring to FIGS. 1-9, several embodiments of the edible puzzle are shown. The edible puzzles provide consumers with added play value by allowing the consumers to form the increasingly complex and recognizable structures by manually manipulating the food pieces 12 until the complementary-shaped food pieces 12 fit together. Each of the food pieces 12 preferably abuts at least one adjacent food piece 12 to form the increasingly complex and recognizable structures. The food pieces 12 are preferably bite-sized such that they can be easily manipulated and consumed by the consumer.

In some embodiments, the food pieces 12 can be provided loosely in separate packaging. Multiple food pieces 12 of the same configurations, but of different colors, can also be provided in the packaging. This requires the consumer to hunt for and gather the necessary food pieces 12, and by trial and error find the appropriate food pieces 12 to complete the structures, while at the same time allowing the consumer to mix and match different colored food pieces 12 to form the increasingly complex and recognizable structures. The food pieces 12 could also be incorporated in various food items.

With reference to FIGS. 1 and 2, first and second edible puzzles 10, 110 of the present invention are shown. In these edible puzzles 10, 110, the food pieces 12 resemble skeletal segments such as a skull 16, arm bones 18, leg bones 20, a rib cage 22, and a pelvic bone 24. As a result, the food pieces 12 can be arranged to form a skeleton-like creature. Each of the food pieces 12 includes a periphery 14 that defines an outline of the shape of the food piece 12. The periphery 14 can include any regular or irregular shapes. Here, the peripheries 14 of each of the food pieces 12 define at least one of a male periphery 26 or female periphery 28 portion such that the food pieces 12 are complementary to one another to facilitate their arrangement into the skeleton-like creature. Each of the food pieces 12 may assume a similar thickness such that the food pieces 12 appropriately line-up when placed on a planar surface for arrangement. As shown in FIGS. 1 and 2, the food pieces 12 can be arranged to form multiple creatures. This is one example of an embodiment in which multiple solutions are possible.

Each of the food pieces 12 has opposed major surfaces 30 bounded by their peripheries 14. In some embodiments, the bottom major surface (not shown) is flat, while the top major surface 30 is formed with 3-dimensional characteristics as provided by the imprinted form in the starch bed used. Still referring to FIGS. 1 and 2, one of the food pieces 12 includes a pair of eyes 32 represented by first and second spaced circular and raised portions on the major surface 30. These starch-molded food pieces 12 may include any variety of raised portions or recesses, or other 3-dimensional features to give character to each food piece 12. In referring to the embodiments below, it is understood that the separate features discussed, e.g., eyes, mouth, hair, etc., may be provided by any 3-dimensional configuration, e.g., raised or recessed portions, as desired.

Multiple food pieces 12 of the same configurations can be formed of different colors and provided in the same packaging, e.g., multiple red, orange, yellow, green, and blue skulls 16, arm bones 18, leg bones 20, rib cages 22, and pelvic bones 24 provided in a sealed pouch. It should also be appreciated by those skilled in the art that individual food pieces 12 may comprise multiple colors such as in layers, or as swirls of color. The term color includes any color (including black and white), hue, shade, or variation thereof which may be provided by the addition of any natural or synthetic coloring agents, or which is naturally provided by mixing the ingredients of the food pieces 12 together. With respect to flavor, the food pieces 12 can have any combination of flavors. Each food piece 12 can have a different flavor than other food pieces 12, each food piece 12 can have multiple flavors, or each of the food pieces 12 can have the same flavor.

The food pieces 12 preferably have a uniform texture and composition throughout. By uniform composition, it is understood that the food pieces 12 will contain similar levels of moisture, sweetener, fruit, and gelling agent. Also, the texture and density of the food pieces 12 will be approximately equal. In other embodiments, the food pieces 12 can have dissimilar textures and compositions.

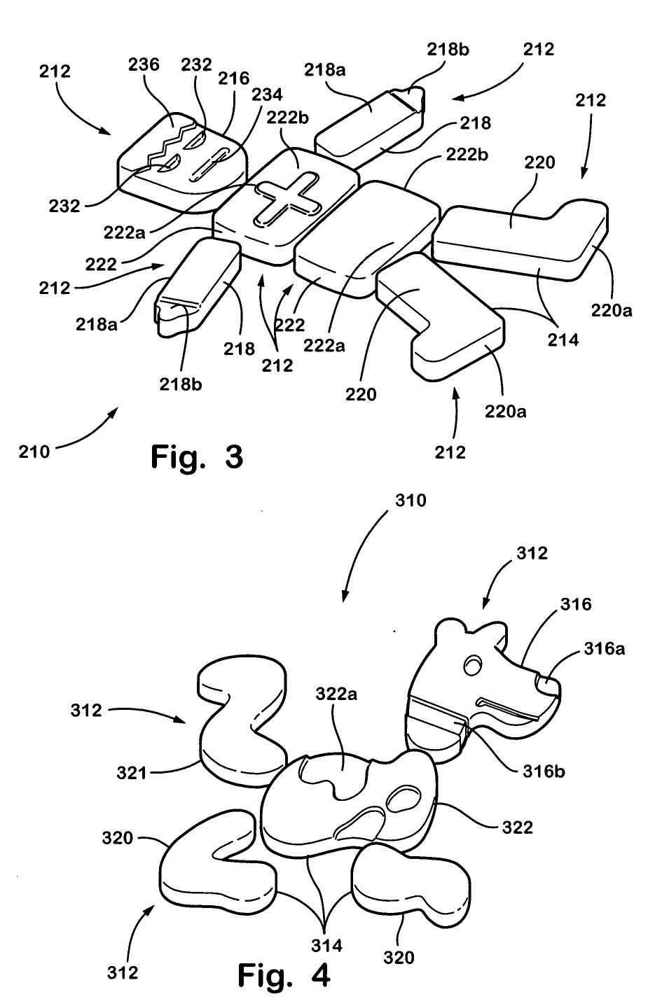

Referring to FIG. 3, a third edible puzzle 210 is shown. Here, the food pieces 212 are arranged to resemble a biped such as Frankenstein. One of the food pieces 212 is in the shape of a head 216 having a pair of eyes 232, a mouth 234 that is represented by a generally rectangular shape positioned below the eyes 232, and hair 236 that is represented by a saw tooth pattern.

Arranged below the head are two food pieces 212 that abut one another to form torso pieces 222 of the biped. In viewing one of the torso pieces 222, a shaped section 222a is set against a background 222b to give the appearance of clothing worn by the biped. Abutting the upper torso piece 222 are two food pieces 212 in the shape of arms 218 with sleeve 218a and recessed hand 218b portions. The sleeve portion 218a is generally rectangular with an irregularly shaped hand portion 218b. Abutting the lower torso piece 222 are the last two food pieces 212 forming this edible puzzle. These food pieces 212 are in the shape of legs 220.

FIGS. 4-6 illustrate additional edible puzzles of the present invention in which the food pieces resemble parts of a creature such as an animal or animated character. In each of these embodiments, the plurality of food pieces include at least one food piece resembling a head, at least one food piece resembling a torso, and at least one food piece resembling an appendage. The appendages shown include arms, legs, feet, wings, and tails.

Referring to FIG. 4, the edible puzzle 310 includes a plurality of food pieces 312 that are arranged to resemble a canine. Here, the head piece 316 is in the shape of a canine's head 316 complete with a nose 316a and a collar 316b. The torso piece 322 is in the shape of a canine body 322 that includes spots 322a. The appendage pieces 320, 321 are in the shape of canine legs 320 and a canine tail 321. The head piece 316, leg pieces 320, and tail piece 321 all abut the torso piece 322 about the periphery 314 of the torso piece when properly arranged.

Referring to FIG. 5, the edible puzzle 410 includes a plurality of food pieces 412 that are arranged to resemble a spider. The head piece 416 is in the shape of a spider's head 416 complete with markings 416a. The torso piece 422 is in the shape of a spider's abdomen also complete with markings 422a. The appendage pieces are in the shape of spider legs 420 with a portion of the legs 420 being formed with two abutting leg sections 420a, 420b. The leg pieces 420 can be arranged about the head piece 416 or the torso piece 422, or both.

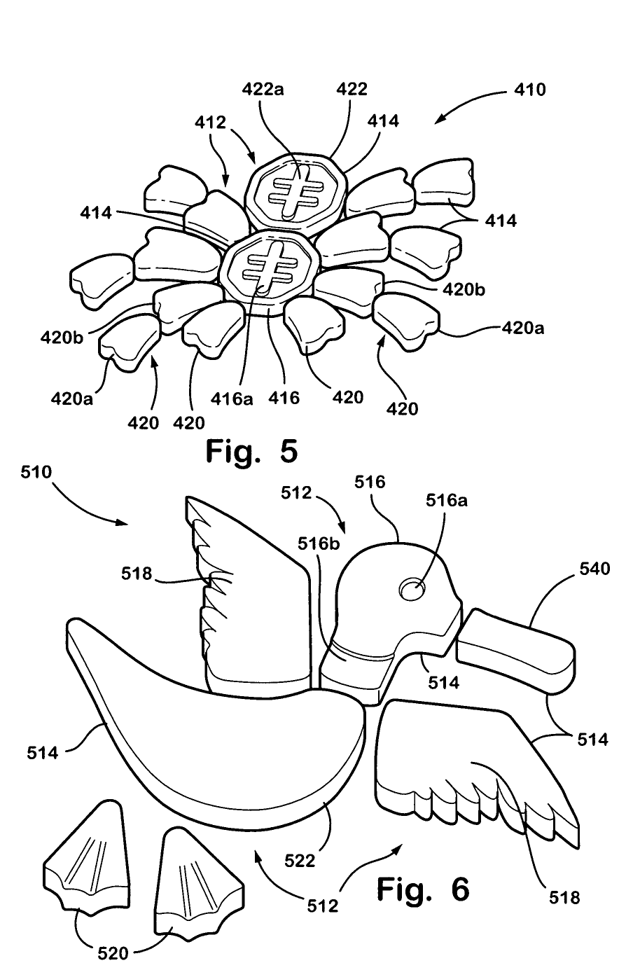

Referring to FIG. 6, the edible puzzle 510 includes a plurality of food pieces 512 that are arranged to resemble a bird, such as a duck. The head piece 516 is in the shape of a bird's head 516 complete with separate eye 516a and neck portions 516b. The torso piece 522 is in the shape of a bird's torso 522. The appendage pieces are in the shape of two wings 518, two feet 520, and a beak 540. The head piece 516, wing pieces 518, and feet pieces 520 each abut the torso piece 522. The beak piece 540 abuts the head piece 516.

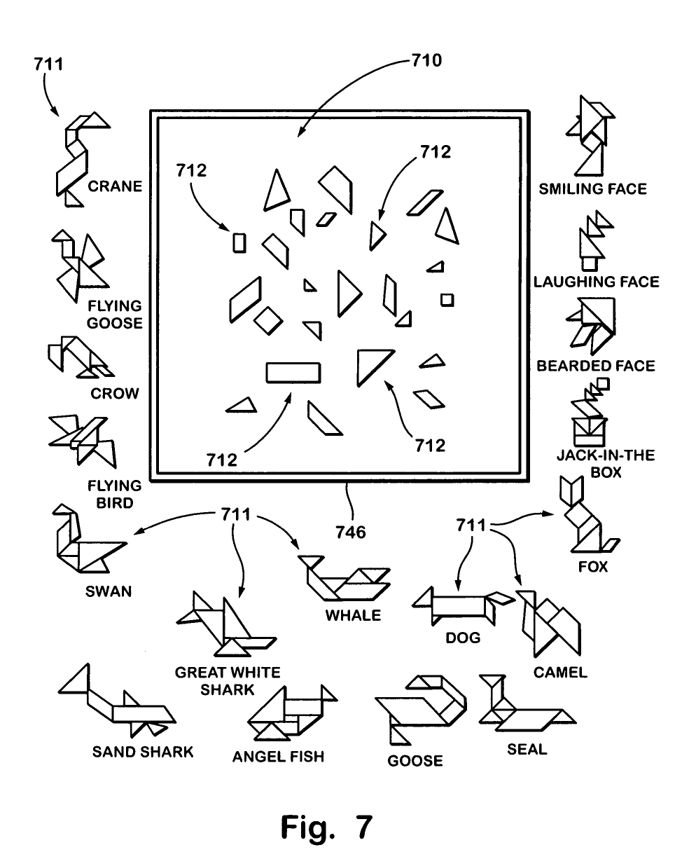

Referring to FIG. 7, another edible puzzle 710 of the present invention is shown. Here, the food pieces 712 are capable of forming multiple complex and recognizable structures 711 such as a crane, flying goose, crow, flying bird, swan, sand shark, great white shark, whale, angel fish, goose, seal, camel, dog, fox, jack-in-the-box, bearded face, laughing face, and smiling face shapes, respectively. In other words, this edible puzzle 710 has multiple solutions. A blank board 746 is illustrated for supporting the food pieces 712 to be arranged. The food pieces 712 preferably assume simple geometric shapes to form these increasingly complex and recognizable structures. Most preferably, the food pieces 712 are triangular and quadrilateral shaped.

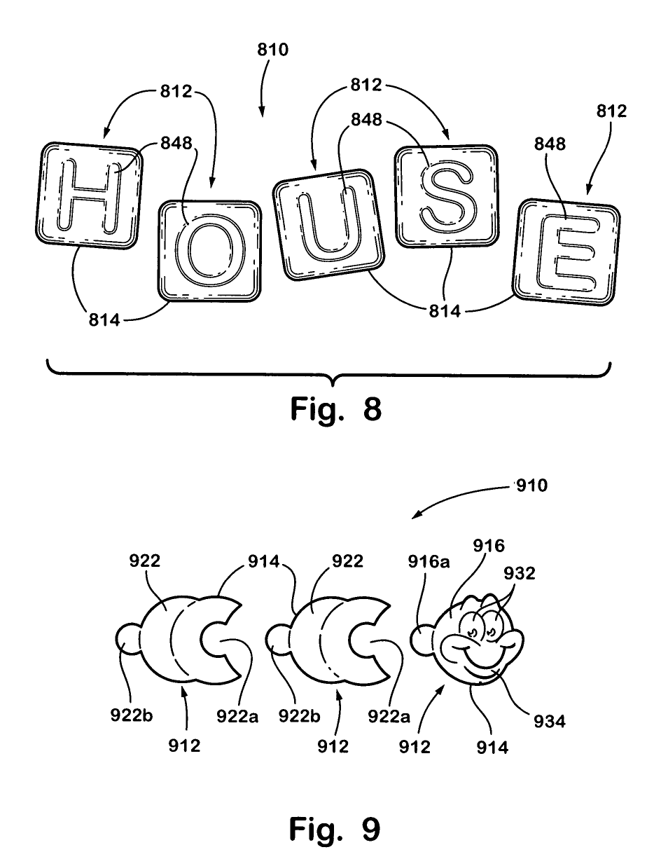

Referring to FIG. 8, yet another edible puzzle 810 of the present invention is shown. Here, each of the food pieces 812 have a box-like shape with rectangular peripheries 814. The food pieces 812 can be of different colors, each with a raised or recessed alphabetic character 848, e.g., capital letters, outlined and spaced from the peripheries 814. As a result, the plurality of food pieces 812 can be arranged to form recognizable words or phrases. Of course, numerals or other symbols could replace all or a portion of the alphabetic characters 848.

Referring to FIG. 9, a still further edible puzzle 910 of the present invention is shown. Here, only two basic food pieces 916, 922 are provided to resemble parts of an animated character, in this case a worm. One of the food pieces 912, the body piece 922, includes a socket 922a at one end and a projection 922b at the opposite end that mates with the sockets 922a of adjacent body pieces 922 such that multiple body pieces 922 can be joined together in an end-to-end manner to form longer worm bodies. The other food piece 912, the head piece 916, includes a projection 916a that can be inserted into the socket 922a of the body piece 922 to form the animated character, i.e., the worm. A face of the head piece 916 includes eyes 932 and mouth 934 that are distinguished by their 3-dimensional character. Each food piece 912 in this embodiment may have a different color and/or flavor, and if multiple body pieces 922 and head pieces 916 are provided in a package (not shown), there may be multiple combinations of colors and/or flavors that can be assembled into short or long worms to form the animated character. In this manner, increasingly complex and recognizable structures can be formed by physically interconnecting the food pieces 912.

It should be appreciated that the increasingly complex and recognizable structures formed are not limited to those shown. Other structures may be contemplated that have not been specifically set forth herein. Obviously, many modifications and variations of the present invention are possible in light of the above teachings. The invention may be practiced otherwise than as specifically described within the scope of the appended claims.

1. A food product for providing play value to consumers, comprising:
a plurality of individual food pieces with at least one of said food pieces having a first configuration and at least one of said food pieces having a second configuration different than said first configuration and complementary to said first configuration,
said plurality of food pieces being edible and arrangeable as a puzzle to form an increasingly complex and recognizable structure, and
each of said plurality of food pieces being starch-molded fruit pieces comprising a sweetener and a gelling agent.

2. A food product as set forth in claim 1 wherein each of said plurality of food pieces comprises from 30 to 90 weight percent of said sweetener, from 0.01 to 30 weight percent fruit, and from 0.01 to 15 weight percent of said gelling agent, based on a total weight of said food pieces.

3. A food product as set forth in claim 1 wherein at least one of said plurality of food pieces includes a first color and at least one of said plurality of food pieces includes a second color different than said first color.

4. A food product as set forth in claim 1 wherein each of said plurality of food pieces resemble skeletal segments of a creature.

5. A food product as set forth in claim 4 wherein said plurality of food pieces include at least one food piece resembling a skull, at least one food piece resembling an arm bone, at least one food piece resembling a leg bone, at least one food piece resembling a rib cage, and at least one food piece resembling a pelvic bone, such that said plurality of food pieces can be assembled to form a skeleton-like creature.

6. A food product as set forth in claim 1 wherein said plurality of food pieces include at least one food piece resembling a head, at least one food piece resembling a torso, and at least one food piece resembling an appendage.

7. A food product as set forth in claim 6 wherein said appendage is at least one of a leg, an arm, a wing, or a tail.

8. A food product as set forth in claim 1 wherein said recognizable structure has a skeletal resemblance.

9. A food product as set forth in claim 1 wherein said recognizable structure is an animal.

10. A food product as set forth in claim 1 wherein said recognizable structure is a word.

11. A food product as set forth in claim 1 wherein at least one of said plurality of food pieces have a male periphery portion and at least one of said plurality of food pieces have a female periphery portion for abutting said male periphery portion.

12. A food product as set forth in claim 1 wherein a first of said plurality of food pieces has a projection and a second of said plurality of food pieces has a socket sized for mating with said projection such that said first and second food pieces can be interconnected to form said increasingly complex and recognizable structure.

13. A food product as set forth in claim 12 wherein a third of said plurality of food pieces includes both a projection and a socket and said second food piece includes a projection for mating with said socket of said third food piece such that said first, second, and third food pieces can be interconnected to form another increasingly complex and recognizable structure.

14. A food product as set forth in claim 13 wherein each of said first, second, and third food pieces is a different color.

15. A food product as set forth in claim 14 wherein each of said first, second, and third food pieces is a different flavor.

16. A food product for providing play value to consumers, comprising:
a plurality of individual food pieces with at least one of said food pieces having a first configuration and at least one of said food pieces having a second configuration different than said first configuration and complementary to said first configuration,
said plurality of food pieces being edible and arrangeable as a puzzle to form multiple increasingly complex and recognizable structures.

17. A food product as set forth in claim 16 wherein each of said plurality of food pieces are a starch-molded fruit piece.

18. A food product as set forth in claim 16 wherein a first of said plurality of food pieces has a projection and a second of said plurality of food pieces has a socket sized for mating with said projection such that said first and second food pieces can be interconnected to form said increasingly complex and recognizable structure.

19. A food product as set forth in claim 18 wherein a third of said plurality of food pieces includes both a projection and a socket and said second food piece includes a projection for mating with said socket of said third food piece such that said first, second, and third food pieces can be interconnected to form said increasingly complex and recognizable structure.

20. A food product as set forth in claim 19 wherein each of said first, second, and third food pieces is a different color and flavor.
